(19) United States
(12) Patent Application Publication
(10) Pub. No.: US 2024/0398650 A1
(43) Pub. Date: Dec. 5, 2024

(54) Psoas Stretching Apparatus

(71) Applicant: Courtney J. Grays, Sioux Falls, SD (US)

(72) Inventor: Courtney J. Grays, Sioux Falls, SD (US)

(21) Appl. No.: 18/660,604

(22) Filed: May 10, 2024

Related U.S. Application Data
(60) Provisional application No. 63/470,406, filed on Jun. 1, 2023.

(51) Int. Cl. A61H 1/02

(52) U.S. Cl. CPC A61H 1/0218; A61H 1/0255; A61H 2201/0107; A61H 2201/0192; A61H 2201/1253; A61H 2201/1642; A61H 2203/0412

(57) ABSTRACT

A psoas stretching apparatus allows a user to release their tight psoas muscles. To help the user target difficult to reach psoas muscles that are otherwise ignored in conventional stretching regimens, the psoas stretching apparatus includes a ground engaging base connected to a pair of upwardly extending support structures. The pair of support structures, padding, and pin elements are configured to adjust the angle and height of a convex leg stabilization structure that supports and cradles the user's leg while providing leverage for the psoas stretch.

The instant utility patent application claims the benefit of U.S. provisional application No. 63/470,406.

### FIELD OF THE INVENTION

Lower back pain is one of the most common reasons people see a healthcare provider. Many lower back issues are caused by anterior pelvic tilt. Anterior pelvic tilt is when the pelvis is tilted forward, causing an individual to curve their spine to stand straight. The arch in the lower back creates constant tension, resulting in lower back pain. This can lead to an uneven distribution of pressure on the spinal column and intervertebral discs. This constant spinal pressure can cause the intervertebral discs to protrude out and press on nerve roots causing pain or other nerve sensations. Anterior pelvic tilt happens when the psoas muscles are compressed and pull the pelvis down.

A pair of psoas muscles are hidden deep within the body, making them hard to locate and often missed in conventional stretching regimens. The pair of psoas muscles start at the top of the lumbar spine, extend through the pelvis and end at the top of the femur. The pair of psoas muscles help connect the top and lower half of the body. The pair of psoas muscles get tight or compressed by our modern lifestyle of sitting in cars, sitting at the computer, sleeping in fetal position, and many similar movement patterns. If the pair of psoas muscles get compressed and shortened for prolonged periods, they can become stuck in that position. The shortened psoas muscles become locked and pull on one's lumbar spine resulting in anterior pelvic tilt causing lower back pain. When a muscle is locked it does not open or release anymore. A muscle that is 12 inches long may only stretch to 10 inches long. Locked and contracted muscles squeeze blood vessels within the muscle, compressing the blood vessels restricting blood flow and reducing oxygen and nutrients carried to the muscle. This muscle tightness needs to be released to open up compressed blood vessels and increase arterial blood flow to give the muscles the nutrients needed to unlock.

The kneeling lunge stretch is an exercise that targets tight psoas muscles.

Traditionally, the kneeling lunge stretch is done with the back and front leg in parallel, which stretches the psoas, but not in the most effective way, due to the anatomy of the psoas muscle. The psoas muscle is attached to the lesser trochanter, which is in the back of the femur. This wraps the psoas muscle around the thigh. By rotating the back leg, this brings the lesser trochanter more in line with the body. Rotating the back leg to bring the attachment site of the psoas muscle more in line with the torso enables a better stretch. The origin of the psoas muscle goes to the front of the body, when taking the back leg and rotating it so it's perpendicular to the torso. For this advanced kneeling lunge stretch to be effective, the torso needs to be square to the front knee. Then the individual grabs the ankle of the leg perpendicular to the torso and pulls it to the buttocks. This gives the psoas muscle a deeper stretch than the traditional kneeling lunge stretch.

A problem with performing an advanced kneeling lunge stretch is that it takes substantial flexibility to achieve. Individuals with tight and shortened psoas muscles have limited flexibility as a direct result of the psoas muscle tightness and compression. This limited flexibility makes it difficult to perform the advanced kneeling lunge stretch necessary to lengthen compressed psoas muscles. Further, kneeling lunge stretches are traditionally held for 30 seconds and repeated 5 times per session, because longer durations are painful to the arm holding the stretch.

Since the advanced kneeling lunge stretch reduces lower back pain, but has a high degree of difficulty to perform, a solution is needed to make this stretch accessible to everyone.

Longer psoas muscle stretching is needed to allow blood flow to this area. A solution is needed for these compressed psoas muscles that are stuck in that position. A solution to reverse the damage of shortened psoas muscles and attempt to lengthen them back to their original size in a pain-free way which can be done for an extended length of time.

### BRIEF SUMMARY OF THE INVENTION

A psoas stretching apparatus is disclosed comprising a ground engaging base that is connected to a pair of upwardly extending support structures. The pair of support structures are configured to adjust the angle and height of a convex leg stabilization structure that supports and cradles the user's leg while providing leverage for the psoas stretch. The psoas stretching apparatus provides tension relief to the psoas muscles which are difficult to reach during conventional stretching. Muscles stretched and unlocked by the psoas stretching apparatus may include, but are not limited to, the psoas major, psoas minor, iliopsoas, iliacus, rectus femoris, sartorius and combinations of these muscles that make up the hip flexor muscle group.

When laying one leg on the leg stabilization structure of the psoas stretching apparatus, weight is distributed evenly across the leg, instead of at a singular point, such as when a user is holding their ankle during a kneeling lunge stretch. This allows for a longer psoas stretch, resulting in more muscle tension released per stretching session.

Performing an advanced kneeling lunge stretch while holding the ankle by hand can possibly result in the hand slipping and the user losing the stretch, or even falling over causing harm to themselves. The psoas stretching apparatus substantially reduces the effort required for users to perform the kneeling lunge stretch and hold it for minutes even with limited flexibility. With the apparatus, relatively little arm strength is needed to achieve this stretch. For individuals with both limited and great flexibility, using the psoas stretching apparatus is a safer alternative because the user does not need to worry about maintaining balance. The device does most of the balancing for them. The psoas stretching apparatus creates a safer environment for users to stretch their psoas regardless of flexibility and individual range of motion.

A user with poorer flexibility may not have access to the advanced kneeling lunge stretch because their muscles are too tight to do it. Embodiments of the invention comprise a psoas stretching apparatus that provides stability and comfort that allow users to get the benefits of this great stretch, by doing substantial parts of the work for the user. The user obtains the psoas healing properties of this stretch without months of increasing their range of motion, which would normally be required to hold the advanced kneeling lunge stretch.

The present invention allows an individual to stretch the psoas muscle without an additional person. The leg stabilization structure is padded from top to bottom to maximize comfort for the user. The adjustability of the leg stabilization structure includes movement along the horizontal and vertical axis. In some embodiments the angle of the leg stabilization structure relative to the ground is adjustable as well. The ability to adjust for user height and desired angle make it accessible for users with different degrees of flexibility. Some users have a limited range of motion, others have a great deal of flexibility and want to be challenged. Both users will be able to find an optimal leg stabilization position based on their desired comfort level. The leg stabilization structure is an inclined plane that the leg sits on and has a convex curvature where the ankle and foot meet. This adds to the comfort and duration the psoas stretch can be maintained. Preferably, the leg stabilization structure has a padded portion comprising a resting surface with a concave contour so that the leg is secured on the inclined cushioned plane. There is additional cushion support for the knee to maximize comfort for a longer stretch.

### BRIEF DESCRIPTION OF THE DRAWINGS

To more fully describe embodiments of the present invention, reference is made to the accompanying drawings. These drawings are not to be considered limitations in the scope of the invention but are merely illustrative.

FIG. 1 is a side view of the device in assembled form in accordance with an embodiment of the present invention.

FIG. 2 is another side view of the device in assembled form in accordance with an embodiment of the present invention.

FIG. 3 is a side view of the device in assembled form in accordance with an embodiment of the present invention.

FIG. 4 is another side view of the device in assembled form in accordance with an embodiment of the present invention.

FIG. 5 illustrates a person performing the advanced kneeling lunge stretch.

FIG. 6 illustrates a person performing the advanced kneeling lunge stretch.

FIG. 7 illustrates the device in use by a person in a stretching position according to an embodiment of the present invention.

FIG. 8 is a front view of the device in assembled form in accordance with an embodiment of the present invention.

FIG. 9 is a back view of the device in assembled form in accordance with an embodiment of the present invention.

FIG. 10 is a top view of the device in assembled form in accordance with an embodiment of the present invention.

FIG. 11 is a bottom view of the device in assembled form in accordance with an embodiment of the present invention.

FIG. 12 is a side view of the device in assembled form in accordance with another embodiment of the present invention.

FIG. 13 is a side view of the device in assembled form in accordance with another embodiment of the present invention.

FIG. 14 is a side view of the device in assembled form in accordance with another embodiment of the present invention.

FIG. 15 is a side view of the device in assembled form in accordance with another embodiment of the present invention.

FIG. 16 is a side view of the device in assembled form in accordance with another embodiment of the present invention.

FIG. 17 shows a front view of support structures according to another embodiment of the present invention.

FIG. 18 shows a back view of support structures according to another embodiment of the present invention.

FIG. 19 shows a front view of support structures according to another embodiment of the present invention.

FIG. 20 shows a back view of support structures according to another embodiment of the present invention.

FIG. 21 is a side view of the leg stabilization structure according to an alternative embodiment of the present invention.

FIG. 22 shows a back view of support structures according to an alternative embodiment of the present invention.

FIG. 23 shows a front view of support structures according to an alternative embodiment of the present invention.

FIG. 24 shows a back view of support structures according to an alternative embodiment of the present invention.

FIG. 25 shows a front view of support structures according to an alternative embodiment of the present invention.

FIG. 26 is a side view of the device in assembled form according to another embodiment of the present invention.

FIG. 27 is a side view of a ground engaging adjustable armrest and adjustable seat according to an alternative embodiment of the present invention.

FIG. 28 is a side view of the device in assembled form including a ground engaging adjustable armrest and adjustable seat according to an alternative embodiment of the present invention.

### DETAILED DESCRIPTION OF THE DRAWINGS

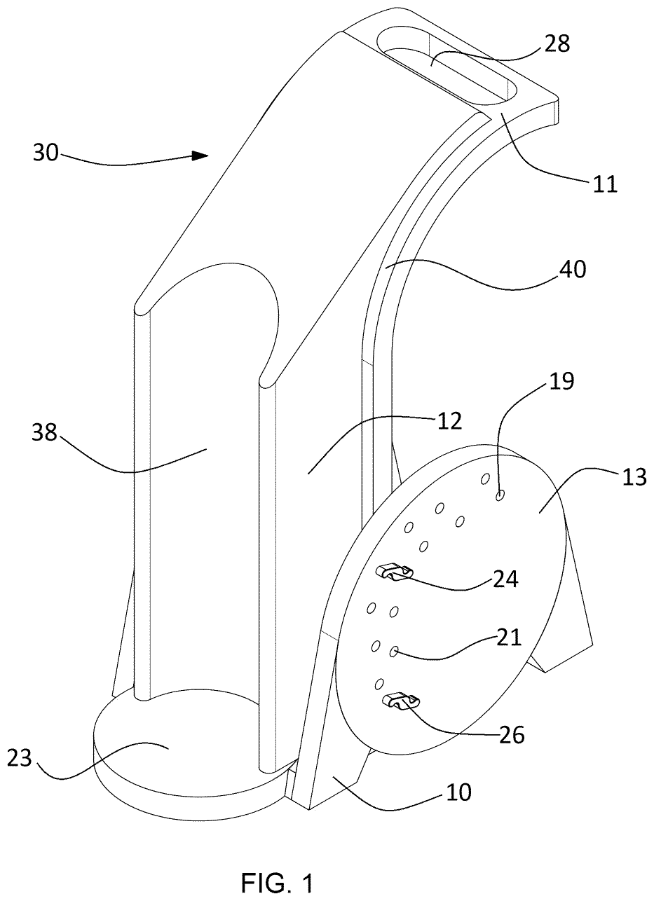

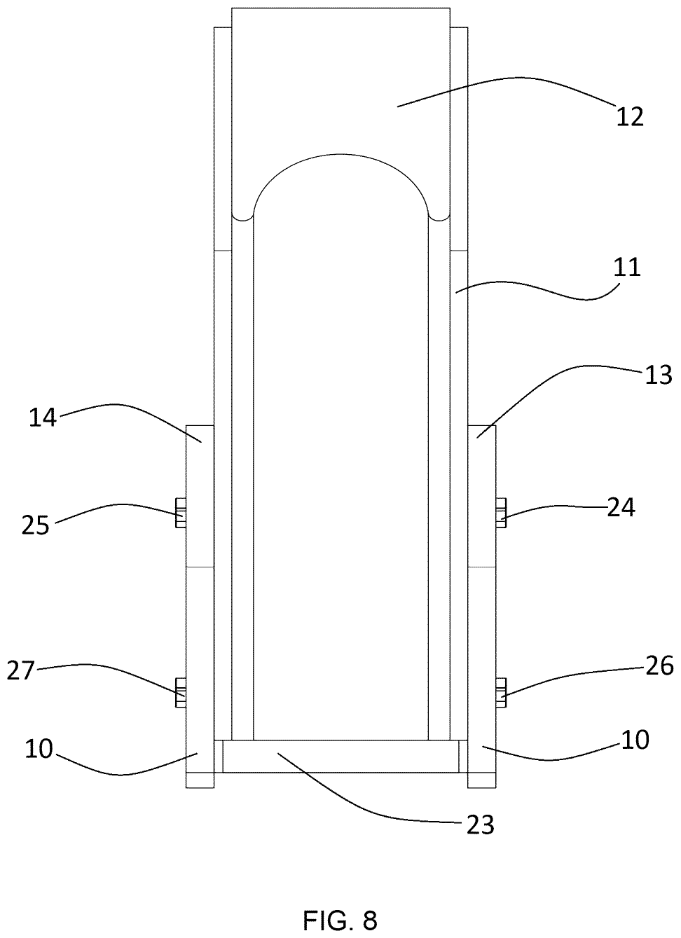

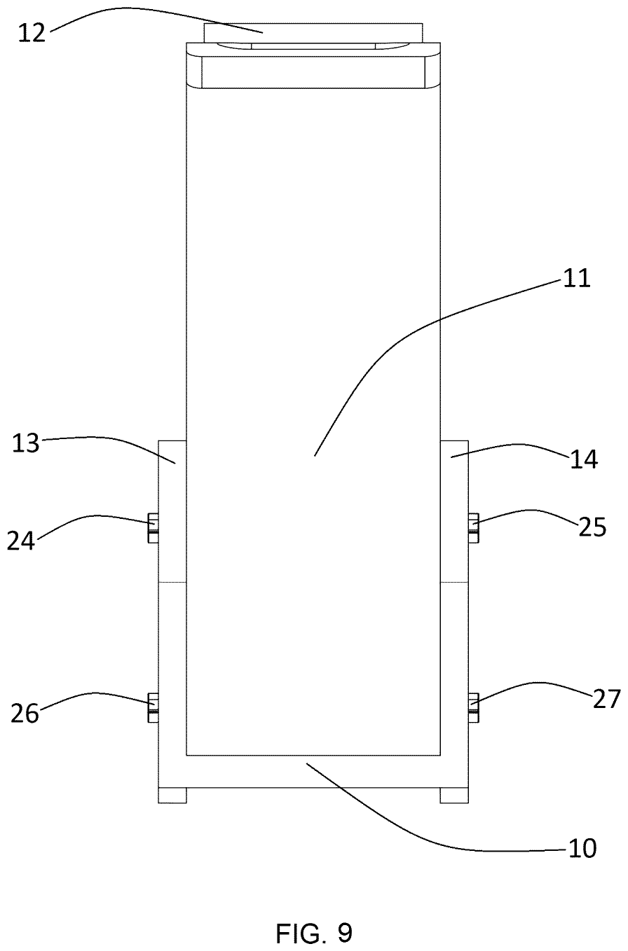

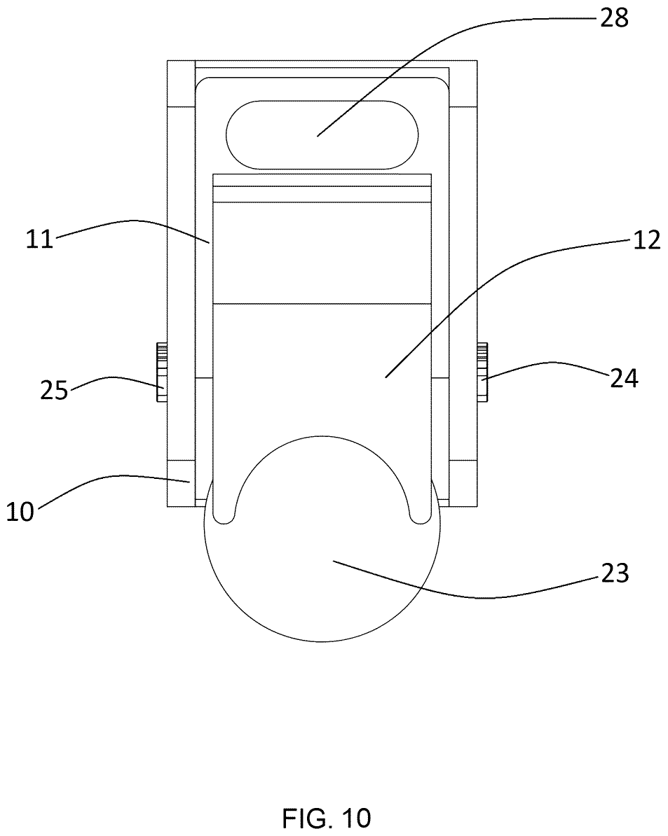

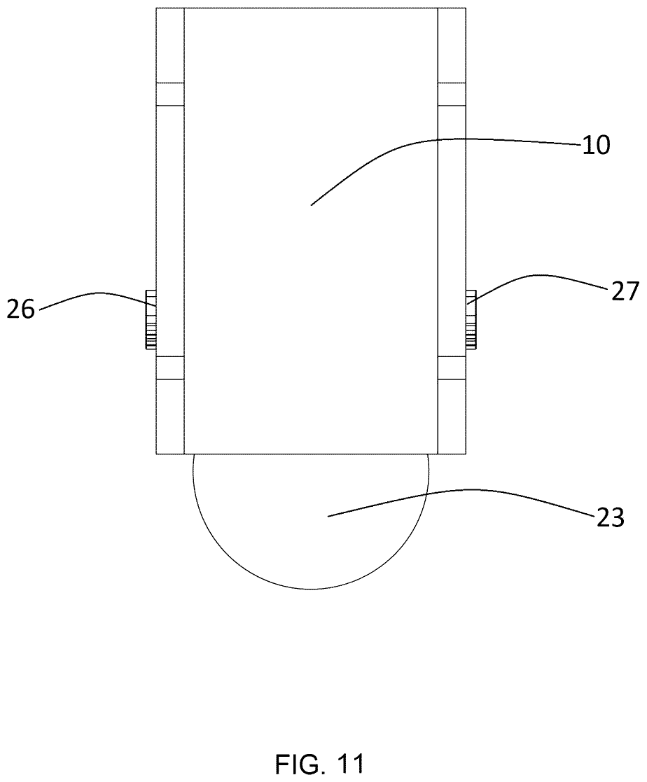

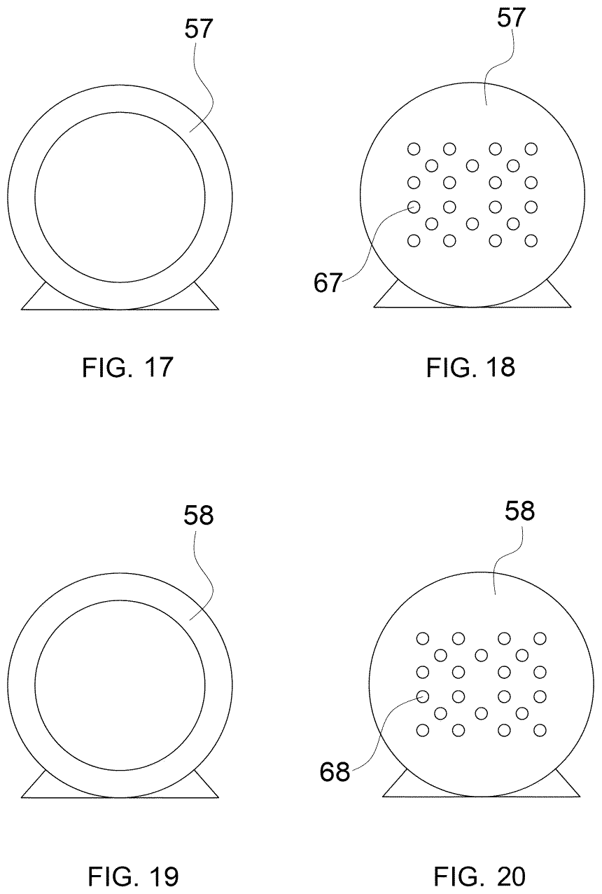

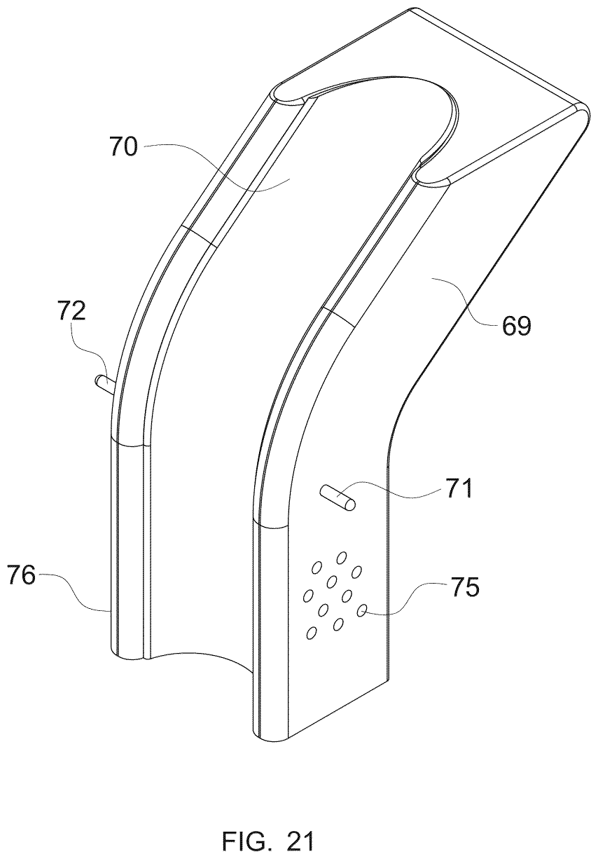

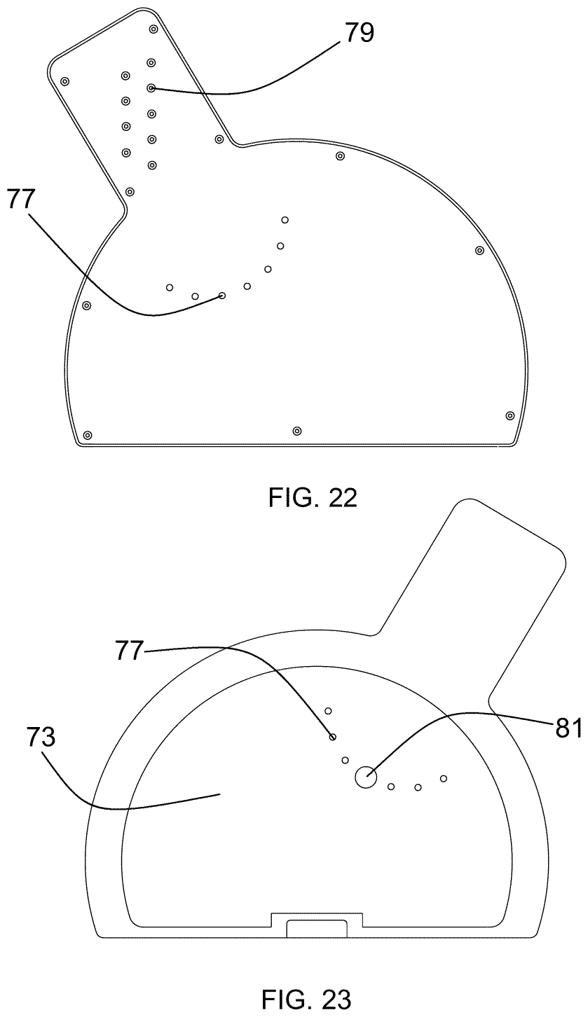

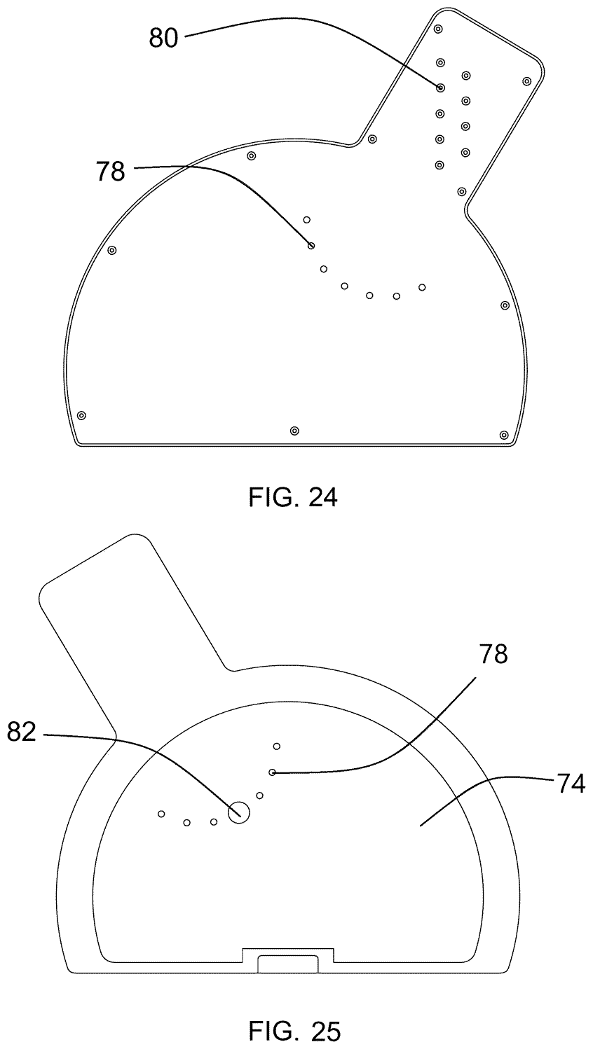

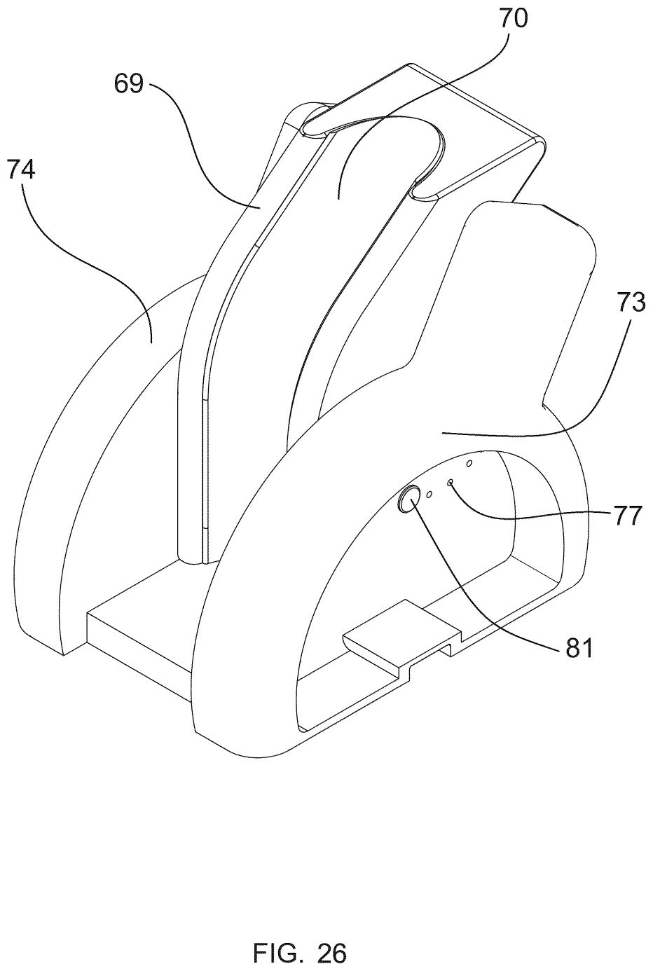

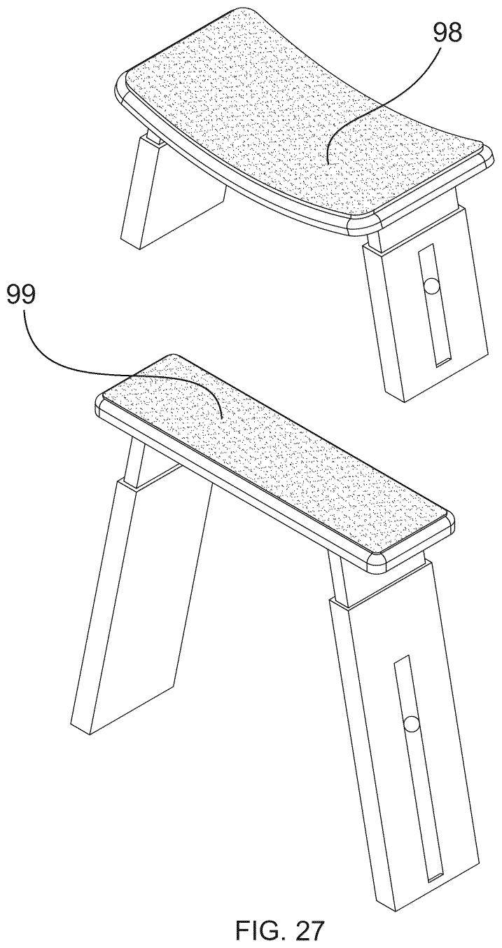

As seen in reference to the drawings FIGS. 1-28, the psoas stretching apparatus 30 of the present invention in one embodiment may include the following elements. Abase 10; two support structures 13 and 14; height adjustment apertures 21 and 22; angle adjustment apertures 19 and 20; adjustment pins 24,25,26, and 27; a knee pad 23; a leg stabilization structure 11; a stabilization pad 12; a handle 28, a plurality of attachment apertures 15,16,17, and 18; and a user 29.

Referring to the embodiment in FIGS. 1, 2, and 3, the psoas stretching apparatus 30 includes a base 10 with a pair of support structures 13,14 rigidly fixed to, or integral with the base 10. From the base 10, the pair of support structures 13,14 protrude upwardly. The base 10 is ground surface engaging to retard movement of the psoas stretching apparatus 30 and provide support for the pair of support structures 13,14. The base 10 may be constructed of metal, wood, plastic or any other suitable material.

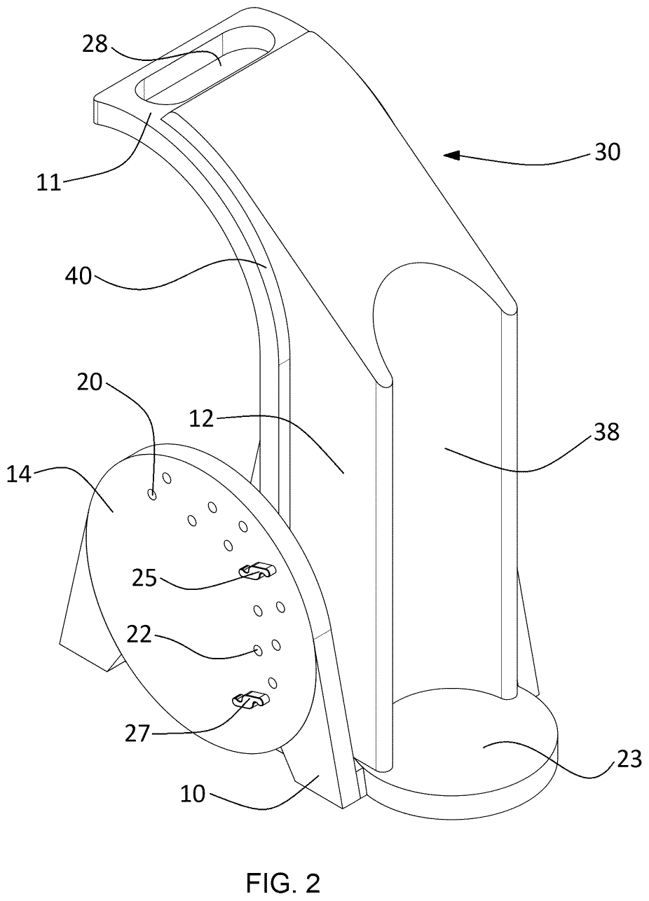

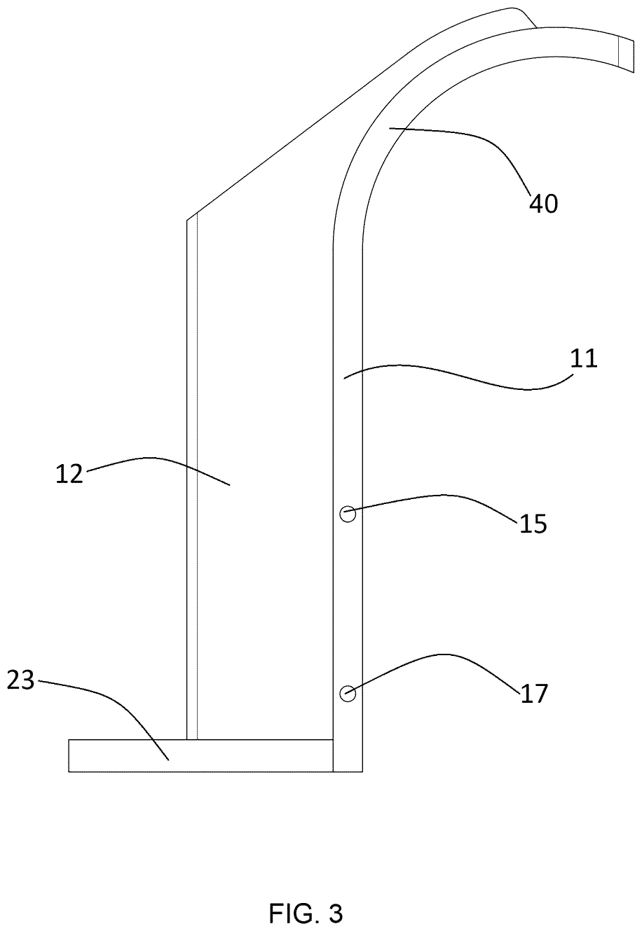

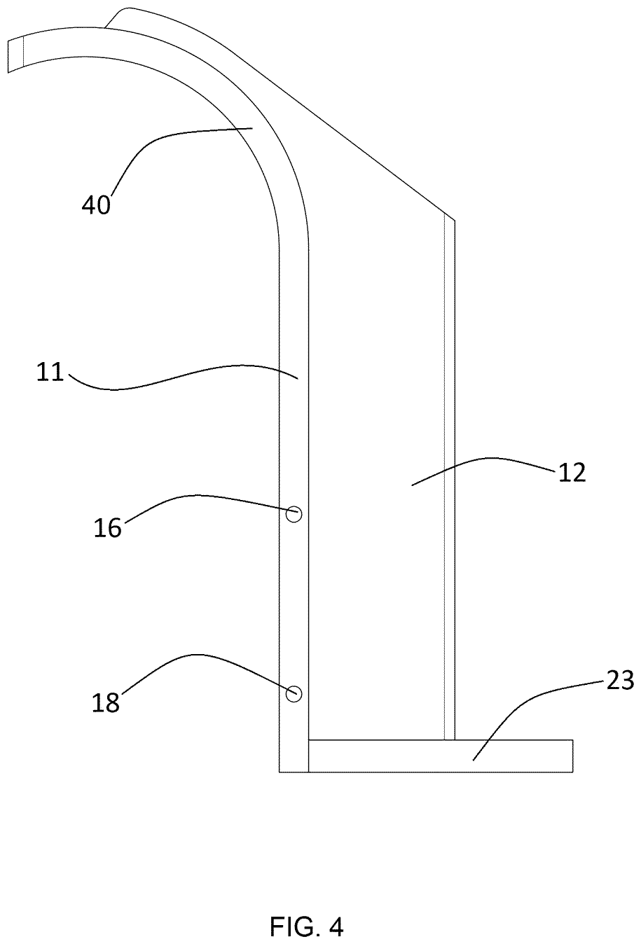

As shown in FIG. 1 and FIG. 2, in one embodiment the pair of support structures 13,14 can be arranged parallel to each other and may be integrally connected to the base 10. In one embodiment, the support structures 13 and 14 include aligned apertures. The angle adjustment apertures 19 and height adjustment apertures 21 in support structure 13 align with the angle adjustment apertures 20 and height adjustment apertures 22 of support structure 14, respectively. Adjustment pins 24,25,26,27 are positioned through the angle adjustment apertures and height adjustment apertures 19,20,21,22 in both support structures 13,14 to attach to the leg stabilization structure 11. The leg stabilization structure 11 shown in FIG. 3 and FIG. 4 is adjustably locked thereto by adjustment pins 24,25,26,27 fitting into two pluralities of attachment apertures 15,17 and 16,18. In this embodiment, the leg stabilization structure 11 is releasably secured to the two support structures 13,14 via adjustment pins 24,25,26,27 that extend through a plurality of height adjustment apertures and angle adjustment apertures 19,20,21,22 of the two support structures 13,14 and into a plurality of attachment apertures 15,17 and 16,18 on each side of the leg stabilization structure 11. The leg stabilization structure 11 is coupled to the two support structures 13,14 in a fixed position. It should be understood that the leg stabilization structure 11 is moveable to any of the height adjustment apertures and angle adjustment apertures 19,20,21,22 of the two support structures 13,14 to accommodate changes in height or angle of the leg stabilization structure 11. Also, although not shown, the adjustment mechanism of the leg stabilization structure 11 and the two support structures 13,14 is not limited to pins and apertures. Different methods can be used and any alternative configurations that would occur to those skilled in the art may also be carried out as an adjustment mechanism. In another embodiment, the leg stabilization structure 11 has no adjustment mechanism and is rigidly fixed to the two support structures 13,14. With reference to the particular embodiment shown in FIGS. 1-11, the two support structures 13 and 14 are elements that have a substantially circular shape. However, alternative embodiments of 13 and 14 with different shapes, e.g. triangular, quadrangular, elliptical, etc., may be used in alternative embodiments.

Referring to FIG. 1,2, in one embodiment the leg stabilization structure 11 includes a stabilization pad 12 and a knee pad 23. Although the leg stabilization structure 11 will be described with reference to FIGS. 1-11, it should be understood that the embodiments can include many alternate forms, In addition, any suitable size, shape, or type of materials could be used to implement the embodiments.

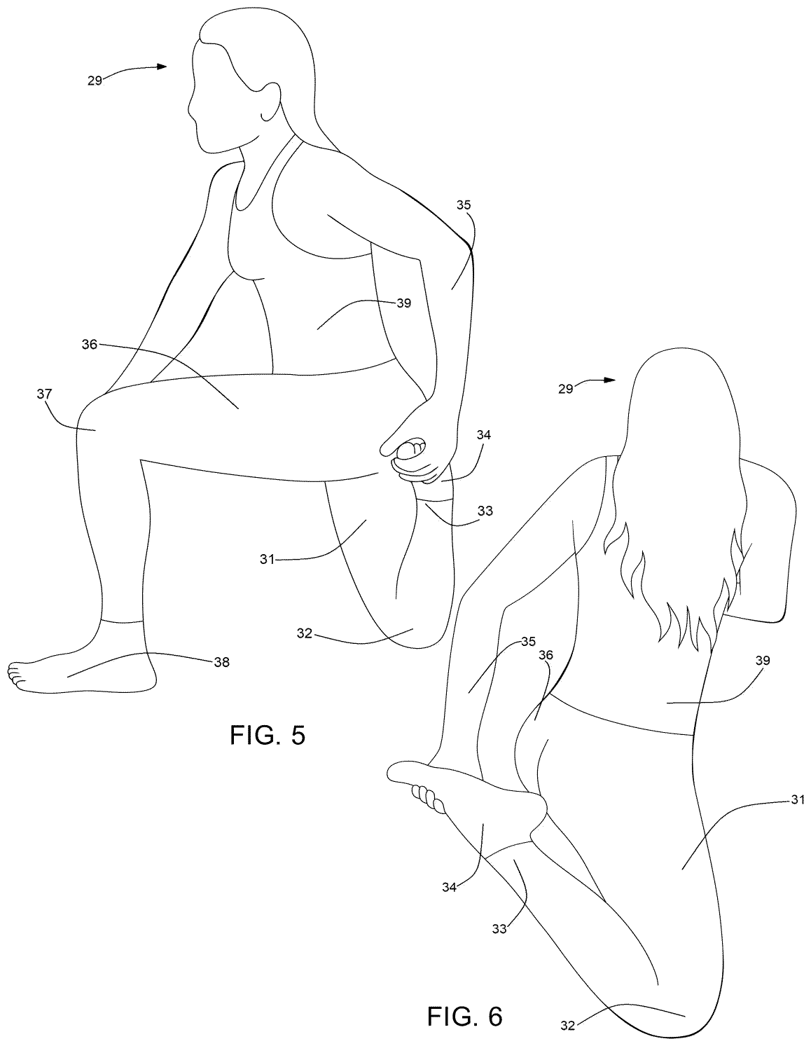

Referring to FIG. 5 and FIG. 6, the advanced kneeling lunge stretch is done with the left leg 36 out in front. The left foot 38 is flat on the floor, while the left leg 36 makes a 90-degree angle at the left knee 37. The right leg 31 and right foot 34 are positioned behind user 29 with the right knee 32 resting on the ground. The right leg 31 is rotated, so it is perpendicular to the torso 39. The torso 39 is square with the left knee 37. User 29 reaches around to grasp their right foot 34 or right ankle 33, so from the right knee 32 resting on the ground to the right foot 34 there is an upward incline.

As shown in FIG. 5 and FIG. 6, users can only hold the stretch for a short duration because of discomfort associated with grasping the right foot 34 and right ankle 33 area. The weight of the right leg 31 is held up by left arm 35 in a small, concentrated surface area of right ankle 33. This results in the left arm 35 experiencing fatigue and right ankle 33 experiencing pain. Therefore, the advanced kneeling lunge stretch is traditionally held for only 30 seconds repeated 5 times per session due to discomfort and/or fatigue. A locked psoas muscle is stuck in a shortened state which restricts blood flow to the area. Stretching the psoas muscles for 30 seconds generally does not unlock the psoas muscles and allow unrestricted blood flow for a long duration. Psoas muscle unlocking is done with psoas stretches of a longer time duration.

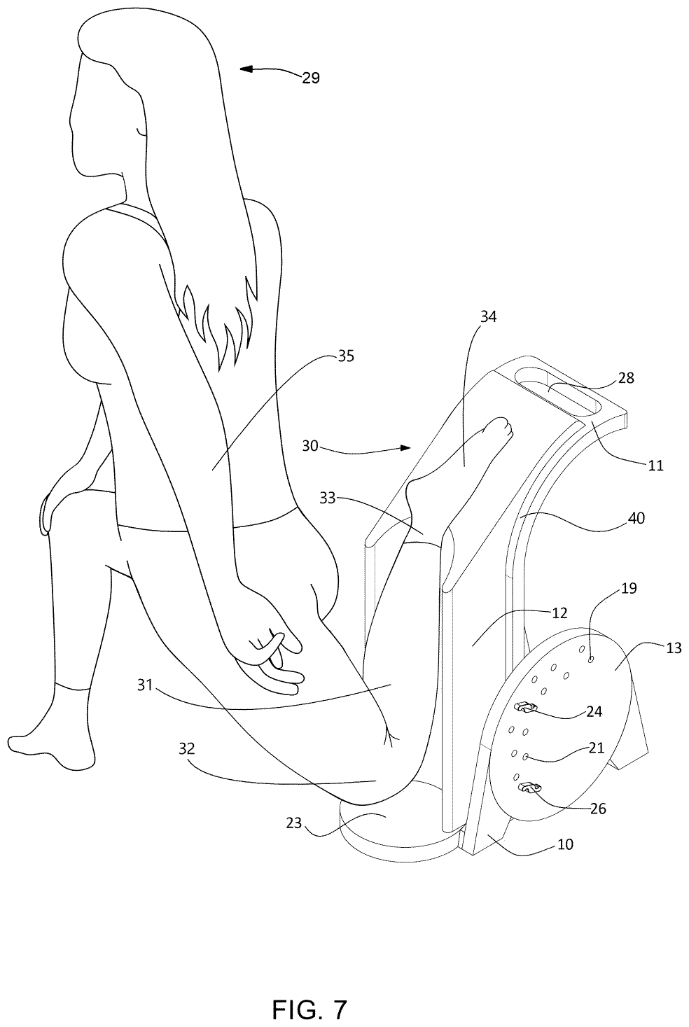

Referring to FIG. 7, in one embodiment of the invention, advantageously, the psoas stretching apparatus 30 comprising a leg stabilization structure 11 with stabilization pad 12 will cradle the user's leg 31 comfortably by evenly distributing the weight of leg 31 across the leg stabilization structure 11 so the leg 31 is rested and supported. A knee pad 23 will provide comfort and protection for the 32 knee of user 29. Arm 35 will no longer hold the leg 31 and the pressure previously on ankle 33 is now evenly dispersed among the entire leg 31.

Additionally, in some embodiments, the leg stabilization structure 11 will provide a substantially convex curvature 40 designed to provide a natural support to match the curvature of the ankle 33 which provides mitigation of the aforementioned negative aspects while performing the advanced kneeling lunge stretch.

Referring to FIG. 7, leg 31 inclines upwardly from the knee 32 towards the foot 34 along the leg stabilization structure 11 at a given angle. In the preferred embodiment, the leg stabilization structure 11 is oriented such that the angle is between about 0 degrees and about 110 degrees and more preferably at about 45 degrees. This angle generally corresponds to the typical leg 31 angle of a user 29 during a kneeling lunge stretch to lengthen the psoas.

In one or more embodiments, the psoas stretching apparatus 30 has a leg stabilization structure 11 that is stationary, stable, and secured to two support structures 13,14 which are joined by base 10. The leg stabilization structure 11 is secured by inserting the adjustment pins 24,26 into apertures 19,21 of the support structure 13 then apertures 15, 17 in FIG. 3 and inserting the adjustment pins 25,27 into apertures 20,22 of the support structure 14 then apertures 16,18 in FIG. 4.

In embodiments, the psoas stretching apparatus 30 may be adjustable. In these embodiments, the leg stabilization structure 11 may be raised or lowered vertically depending on the user's height and the length of their legs. The angle of the leg stabilization structure 11 may be adjusted for the comfort of the user and flexible ability.

Support shaped structures 13,14 may have one or more adjustment apertures configured to accept an adjustment pin along its length. Adjustment pins 26,27 inserted into height adjustment apertures 21,22 and attachment apertures 17,18 can lock the leg stabilization structure 11 to a specific height. Adjustment pins 24,25 inserted into angle adjustment apertures 19,20 and attachment apertures 15,16 can lock the leg stabilization structure 11 to a specific angle.

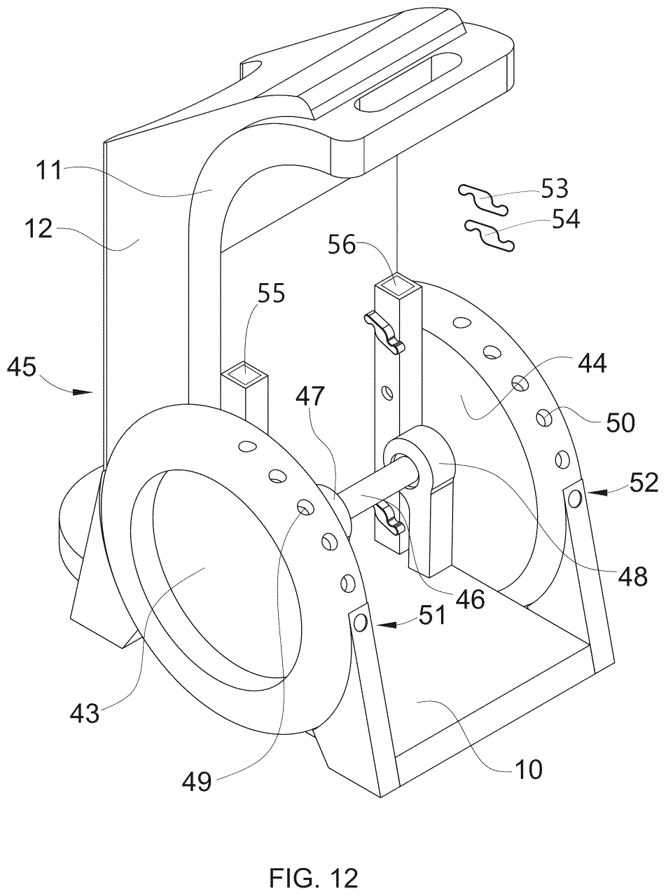

FIG. 12 shows another embodiment of the psoas stretching apparatus. Reference numerals have been used for similar components to reduce repetition of description. The psoas stretching apparatus in FIG. 12 has a leg stabilization structure 11 and stabilization pad 12 rigidly fixed between two parallel support structures 43,44 forming one rotational structure 45. Rotational structure 45 is integrally connected to base 10. A rod-shaped rotation shaft 46 extends horizontally from the center of support structure 43 to the center of support structure 44. Support structures 43 and 44 are coupled to the rod-shaped rotation shaft 46 which rotates in stabilization columns 47,48 secured to base 10. This enables rotational structure 45 to be rotated clockwise and counterclockwise relative to base 10. The rod-shaped rotation shaft 46 goes through stabilization columns 47,48. Stabilization columns 47,48 contain apertures which prevent the rod-shaped rotation shaft 46 from being detached from base 10. The curved surface of support structures 43 and 44 include a plurality of angle adjustment apertures 49,50.

The angle adjustment apertures 49,50 located on rotational structure 45 align with attachment apertures 51,52 in base 10 such that adjustment pins 53,54 are positioned within the aligned apertures to secure the rotational structure 45 in a selected angular position to base 10. The rotational structure 45 is adjustably locked thereto by adjustment pins 53,54 fitting into two pluralities of angle adjustment apertures 49,50. In this embodiment, the rotational structure 45 is releasably secured to base 10. When secured to base 10, the rotational structure 45 provides stability to the psoas stretching apparatus while in use.

Attachment pins 53,54 extending into attachment apertures 51,52 in base 10 can be positioned through any of the angle adjustment apertures 49,50 to accommodate changes in the angle of the rotational structure 45. The rotational structure 45 may optionally have telescoping portions 55,56 attached to support structures 43 and 44 that allow the user to adjust the height of the leg stabilization structure 11.

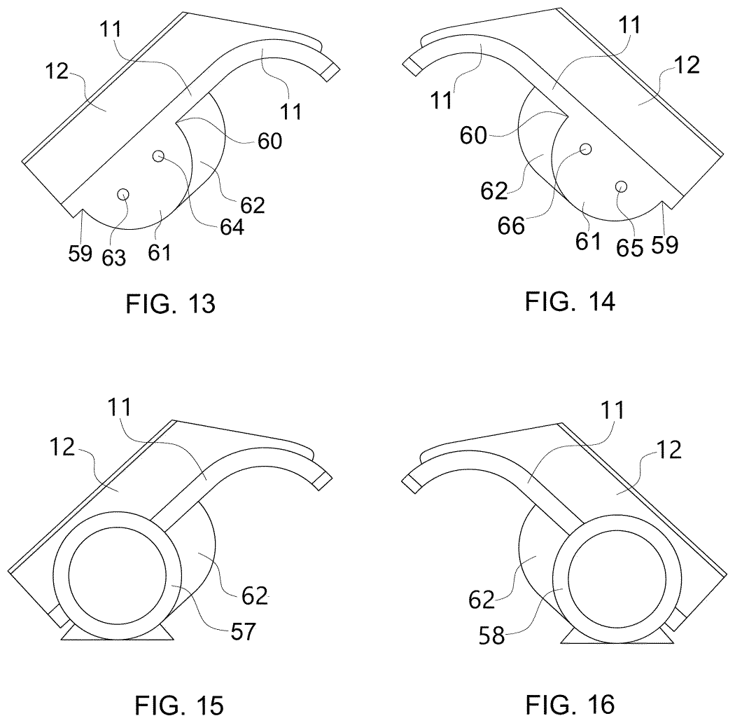

FIGS. 13 to 20 show yet another embodiment of the psoas stretching apparatus with user-controlled rocking adjustment mechanism for use before locking the angle and optionally the height. The psoas stretching apparatus shown in FIG. 13 to 20 is very similar to that shown in the first embodiment and similar reference numerals have accordingly been used. The embodiment shown in FIG. 13 to 20 includes a pair of support structures 57,58 that can be arranged parallel to each other and connected to a leg stabilization structure 11. The leg stabilization structure 11 has a convex curvature with a concave stabilization pad 12 from top to bottom. The opposing ends 59 and 60 of the leg stabilization structure 11 are joined by curvilineal portion 61 which is of a predetermined arc or curvature. Accordingly, the central curvate portion 62 provides a rocking movement on a floor surface for the leg stabilization structure 11. The leg stabilization structure 11 includes two outwardly protruding handles 63,64 and 65,66 on each side, for a total of four handles. The support structures 57 and 58 include aligned apertures. The angle adjustment apertures 67 in support structure 57 align with angle adjustment apertures 68 in support structure 58. The rocking movement of curvate portion 62 allows the protruding handles 63,64,65,66 to be moved into multiple positions. Once handles 63,64,65,66 are in the desired location, the leg stabilization structure 11 can be set into a locked non-movable position by affixing the handles 63,64,65,66 to angle adjustment apertures 67 and 68.

Handles 63,64, are positioned through angle adjustment apertures 67 and 65,66 are positioned through angle adjustment apertures 68 in both support structures 57,58. The leg stabilization structure 11 is adjustably locked thereto by handles 63,64,65,66 fitting into a plurality of angle adjustment apertures 67,68. The leg stabilization structure 11 is coupled to the two support structures 57,58 in a fixed angular position, The fixed angular position of the leg stabilization structure 11 is based on where the rocking movement of curvate portion 62 places the handles 63,64,65,66 relative to angle adjustment apertures 67,68.

Support structures 57,58 may optionally be coupled with telescoping portions such as 55, 56 that would allow the user to adjust the distance between parallel support structures 57,58. This would free the leg stabilization handles 63,64,65,66 to be retained in a different set of angle adjustment apertures 67,68 on support structures 57,58.

FIGS. 21 to 26 show another embodiment of the psoas stretching apparatus. Some of the same reference numerals have been used for similar components to reduce repetition of description. The leg stabilization structure 11 has been substituted by leg stabilization structure 69 which has both convex and concave properties. The leg stabilization structure 69 has a convex curvature along the vertical axis and a concave curvature along the horizontal axis. This improvement removes the need for concave stabilization pad 12. In this embodiment, the stabilization pad 12 has been replaced with a flat padded surface 70.

Leg stabilization structure 69 further includes a pair of outwardly protruding handles 71 and 72, oriented generally orthogonal from the leg stabilization structure 69. Support structures 73 and 74 contain a plurality of height adjustment apertures 79,80 and a plurality of attachment apertures 77,78. Handles 71,72 are positioned through the height adjustment apertures 79,80 to pivotally attach the leg stabilization structure 69 to the pair of support structures 73 and 74. The leg stabilization structure 69 is rotatably retained in the height adjustment apertures 79,80. It should be understood that the leg stabilization structure 69 is moveable to any of the height adjustment apertures 79,80 of the two support structures 73,74 to accommodate changes in height. The height adjustment apertures 79,80 act as a point of suspension therefore the leg stabilization structure 69 is freely pivotable about the height adjustment apertures 79,80. To prevent undesired separation of handles 71,72 from the height adjustment apertures 79,80, the leg stabilization structure 69 is secured to the two support structures 73 and 74 with attachment pins 81,82. Attachment pins 81,82 are positioned through attachment apertures 77,78 into one of the series of angle adjustment apertures 75,76 to lock the leg stabilization structure 69 in a selected angular position.

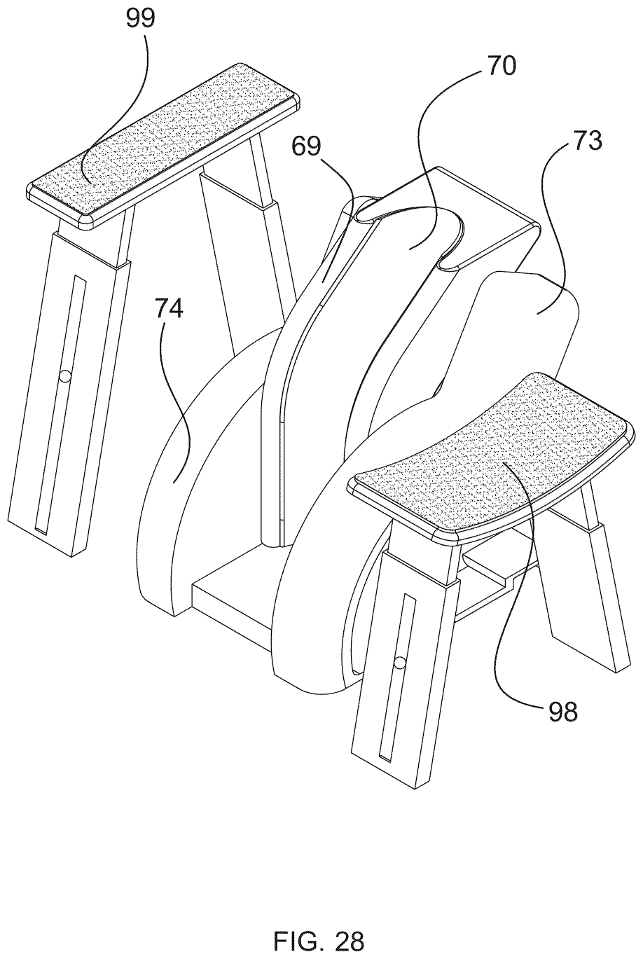

In another embodiment shown in FIG. 27 and FIG. 28, additional user support may include one or more ground engaging adjustable armrests 99 located on the side of the psoas stretching apparatus and an adjustable seat 98 for the thigh and buttocks of the leg not using the psoas stretching apparatus to optimize user comfort. Alternatively, a user may attach the psoas stretching apparatus onto a vertical or horizontal fixed surface such as a wall, bed, chair, or another exercise apparatus.

In another embodiment, the psoas muscle stretching apparatus is equipped with an LCD screen strategically positioned for optimal visibility during use. The LCD screen is connected to an electronic control unit that processes user input and displays relevant information. Users can interact with the apparatus through intuitive controls, selecting parameters such as stretching duration, intensity, and specific stretching modes. The motorized adjustment mechanism allows for dynamic changes to the stretching apparatus's configuration. Users can conveniently modify the angle, tension, or range of motion to tailor the stretching experience to their individual needs. The motor control system is synchronized with the LCD screen, ensuring real-time feedback on the adjustments made.

In operation, the LCD screen guides users through recommended stretching routines, providing visual cues and prompts for optimal utilization of the apparatus. The motorized adjustments, activated by user input or pre-programmed routines, enhance the effectiveness of the stretching process while accommodating users of varying fitness levels and preferences.

This embodiment allows for customizable stretching routines, where users can personalize stretching parameters using the LCD screen and motor control, adapting the apparatus to their specific requirements, real-time feedback, where the LCD screen provides users with real-time information on stretching parameters, ensuring a safe and effective stretching experience, and automated adjustments, where the motorized control system allows for automated modifications to the stretching apparatus, simplifying the user experience and facilitating precise adjustments.

While particular embodiments have been described, various alternatives, modifications, improvements, variations, and substantial equivalents that are or may be presently unforeseen may arise to others skilled in the art. Embodiments of the invention may be produced from any material including but not limited to at least one of the following: polymeric materials, metals, and other materials inorganic and organic and may comprise a combination of any such materials. It is also to be understood that the phraseology and terminology used herein is for the purpose of description and should not be regarded as limiting.

1. A psoas stretching apparatus, comprised of
a base,
an at least one support structure,
a convex leg stabilization structure connected to the base that supports and cradles a user's leg,
where the at least one support structure is configured to adjust the angle and height of the convex leg stabilization structure to provide leverage to a user for stretching.

2. The apparatus of claim 1,
where the leg stabilization structure is further comprised of padding and a resting surface,
where the apparatus is further comprised of cushion support for a user's knee at the base,
the base and support structure being connected by at least two adjustment pins used to adjust the angle and height of the convex leg stabilization structure relative to the base, the pins being placed through at least two support structures.

3. The apparatus of claim 1, further comprising an adjustment fastener for adjusting at least one property of the apparatus selected from the group of angle, height, and both angle and height.

4. The apparatus of claim 1, further comprised of a series of adjustment apertures, and further comprised of fasteners positioned through the height adjustment apertures to pivotally attach the leg stabilization structure to the support structures.

5. The apparatus of claim 1, where the convex leg stabilization structure is oriented at an angle of between about 0 degrees and about 110 degrees with respect to the floor.

6. The apparatus of claim 1, further comprising an at least one ground engaging adjustable armrest located on the opposite side of the psoas stretching apparatus, and an adjustable seat for the thigh and buttocks of the leg not placed in the apparatus, to optimize user comfort.

7. The apparatus of claim 6, where the ground engaging adjustable armrest is detachable from the apparatus.

8. The apparatus of claim 6, where the adjustable seat is detachable from the apparatus.

9. The apparatus of claim 1, further comprising a connection from the base to a fixed surface, where the fixed surface is selected from the group of a wall, bed, chair, another exercise apparatus, and another stable fixture.

10. The apparatus of claim 1, further comprised of a rotation shaft and an at least one telescoping support structure, where adjustment pins are positioned within aligned apertures to secure the rotational shaft in a selected angular position and the telescoping support structure to a height relative to the base.

11. The apparatus of claim 1, where the leg stabilization structure has a convex curvature with a concave stabilization pad.

12. A psoas stretching apparatus comprised of
a base with a knee pad,
a convex leg stabilization structure with a stabilization pad,
an at least one height adjustment aperture mechanism in a support structure connected to the convex leg stabilization structure,
an at least one angle adjustment aperture mechanism in a support structure connected to the convex leg stabilization structure.

13. The apparatus of claim 12, further comprised of an at least one adjustment pin.

14. The apparatus of claim 12, further comprised of a handle connected to the apparatus, and where an adjustment pin is positioned through the angle adjustment aperture to attach to the leg stabilization structure and a second adjustment pin is positioned through the height adjustment aperture to attach to the leg stabilization structure.

15. The apparatus of claim 12, where the leg stabilization structure includes an at least one aperture laterally and a pivot element for altering the inclined angle of the structure to result in an angle of between about 0 degrees to about 110 degrees relative to the floor.

16. The apparatus of claim 12, where the apparatus is secured to two support structures joined to the base, where the convex leg stabilization structure is secured by inserting at least two adjustment pins into apertures of the support structure.

17. The apparatus of claim 12, further comprising a pivot element for rotating the leg stabilization structure for affixing the angle with respect to the base.

18. The apparatus of claim 12, further comprising an at least one ground engaging adjustable armrest located on opposite sides of the psoas stretching apparatus and an adjustable seat for the thigh and buttocks of the leg not placed in the apparatus to optimize user comfort.

19. The apparatus of claim 12, further comprising a pivot element for rotating the leg stabilization structure for affixing the angle with respect to the base.

20. The apparatus of claim 12, where the convex leg stabilization structure is disposed on an inclined plane and further comprising a curvature area for a user's foot and ankle to enable greater leverage during the stretch.

21. The apparatus of claim 12, further comprised of motorized means for adjusting the angle and/or height the leg stabilization structure depending on the user's preferences.
